(19) United States
(12) Patent Application Publication
(10) Pub. No.: US 2026/0085797 A1
(43) Pub. Date: Mar. 26, 2026

(54) METHODS AND SYSTEMS FOR CITY LIFELINE PIPELINE BURST PREVENTION BASED ON IOT LARGE MODEL

(71) Applicant: CHENGDU QINCHUAN IOT TECHNOLOGY CO., LTD., Chengdu (CN)

(72) Inventors: Hanshu SHAO, Chengdu (CN); Junyan ZHOU, Chengdu (CN); Siwei ZENG, Chengdu (CN); Rui RU, Chengdu (CN)

(73) Assignee: CHENGDU QINCHUAN IOT TECHNOLOGY CO., LTD., Chengdu (CN)

(21) Appl. No.: 19/408,327

(22) Filed: Dec. 3, 2025

(30) Foreign Application Priority Data
Sep. 12, 2025 (CN) 202511301706.6

(51) Int. Cl. F17D 5/02; G01L 13/06; G16Y 40/10

(52) U.S. Cl. CPC F17D 5/02; G01L 13/06; G16Y 40/10

(57) ABSTRACT

The present disclosure relates to a method and system for city lifeline pipeline burst prevention based on an IoT large model. The method includes: obtaining fluid pressure data; determining a pipe burst probability of a pipeline network node based on the fluid pressure data; and determining a target valve and a valve opening degree of the target valve based on the pipe burst probability, and controlling the target valve to the valve opening degree.

### CROSS-REFERENCE TO RELATED APPLICATIONS

This application claims priority to Chinese Application No. 202511301706.6 filed on Sep. 12, 2025, the entire contents of which are incorporated herein by reference.

### TECHNICAL FIELD

The present disclosure relates to the field of safety monitoring of city water supply pipeline network, in particular, to methods and systems for city lifeline pipeline burst prevention based on an Internet of Things (IoT) large model.

### BACKGROUND

During the operation of a city water supply pipeline network, pipe burst accidents have become a major safety hazard in the water supply system due to their suddenness and destructiveness. The traditional monitoring of pipe bursts mainly relies on pressure gauges and flow meters inside the pipe network, and monitoring through the pressure drop and other single indicators. However, it is susceptible to interference from factors such as water load fluctuations, equipment failures, etc., resulting in a high misjudgment rate. In addition, the existing monitoring means for distinguishing between pipe bursting and leakage have insufficient ability to provide accurate warnings and cannot initiate appropriate emergency measures in a timely manner.

Therefore, methods and systems for city lifeline pipeline burst prevention based on an IoT large model are desirable to be provided to solve the deficiencies of the current monitoring technology, to realize comprehensive and real-time monitoring of the city water supply pipeline network, and to improve the effectiveness and timeliness of the city lifeline pipeline burst prevention.

### SUMMARY

One or more embodiments of the present disclosure provide a method for city lifeline pipeline burst prevention based on an IoT large model. The method is realized by a system for city lifeline pipeline burst prevention based on an IoT large model, comprising: obtaining fluid pressure data; determining a pipe burst probability of a pipeline network node based on the fluid pressure data; and determining a target valve and a valve opening degree of the target valve based on the pipe burst probability, and control the target valve to the valve opening degree. One or more embodiments of the present disclosure provide a system for city lifeline pipeline burst prevention based on an IoT large model, the system comprising an emergency supervision management platform. The emergency supervision management platform is configured to perform the method for city lifeline pipeline burst prevention based on the IoT large model.

One or more embodiments of the present disclosure provide a non-transitory computer-readable storage medium, wherein the storage medium stores computer instructions, and when the computer reads the computer instructions in the storage medium, the computer executes the method for city lifeline pipeline burst prevention based on the IoT large model.

### BRIEF DESCRIPTION OF THE DRAWINGS

The present disclosure may be further described by way of exemplary embodiments, which may be described in detail with reference to the accompanying drawings. These embodiments are not limiting, and in these embodiments, the same numbers refer to the same structures, wherein:

FIG. 1 is a schematic diagram illustrating an exemplary structure of a system for city lifeline pipeline burst prevention based on an IoT large model according to some embodiments of the present disclosure;

FIG. 2 is a flowchart illustrating an exemplary process of a method for city lifeline pipeline burst prevention based on an IoT large model according to some embodiments of the present disclosure;

FIG. 3 is a flowchart illustrating an exemplary process of generating a risk avoidance instruction according to some embodiments of the present disclosure; and

FIG. 4 is an exemplary schematic diagram for determining a pipe burst probability according to some embodiments of the present disclosure.

### DETAILED DESCRIPTION

In order to illustrate the technical schemes of the embodiments of the present disclosure more clearly, the following briefly introduces the accompanying drawings that are used in the description of the embodiments. Obviously, the accompanying drawings in the following description are only some examples or embodiments of the present disclosure. For ordinary technicians skilled in the art, the present disclosure may also be applied to other similar situations according to these accompanying drawings without any creative effort. Unless obviously obtained from the context or the context illustrates otherwise, the same numeral in the drawings refers to the same structure or operation.

It should be understood that “system”, “device”, “unit”, and/or “module” as used herein is a method used to distinguish different components, elements, parts, sections, or assemblies at different levels. However, other words may be replaced by other expressions if the words serve the same purpose.

As shown in the present disclosure and claims, unless the context clearly dictates otherwise, the words “a”, “an”, “a kind”, and/or “the” are not intended to be specific in the singular and may include the plural. Generally, the terms “comprising” and “including” only imply that the clearly identified steps and elements are included, and these steps and elements do not constitute an exclusive list, and the method or equipment may also include other steps or elements.

Flowcharts are used in the present disclosure to illustrate operations performed by the system according to the embodiments of the present disclosure. It should be understood that the preceding or following operations are not necessarily performed in the exact order. Instead, each step may be processed in reverse order or simultaneously. Also, other operations may be added to these processes, or a step or steps may be removed from these processes.

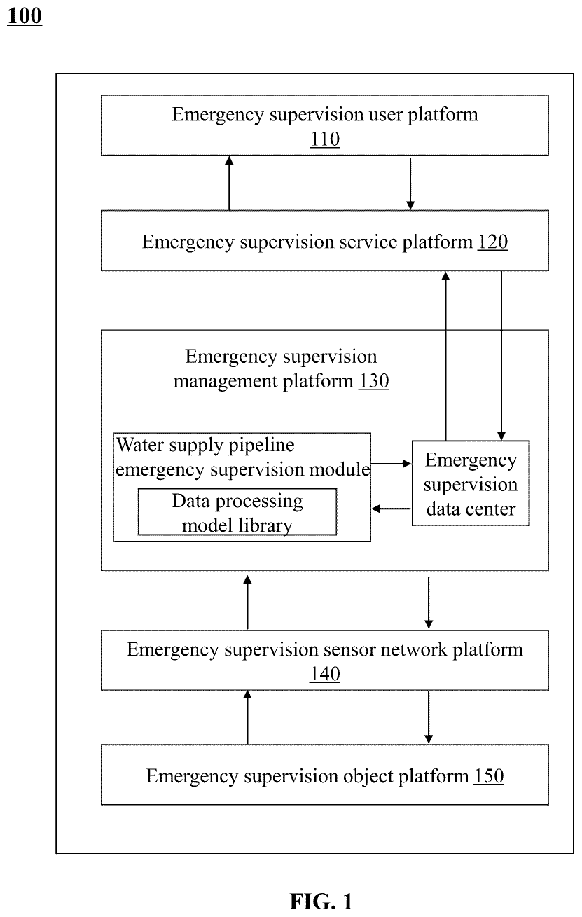

FIG. 1 is a schematic diagram illustrating an exemplary structure of a system for city lifeline pipeline burst prevention based on an IoT large model according to some embodiments of the present disclosure.

In some embodiments, as shown in FIG. 1, the system 100 for city lifeline pipeline burst prevention based on the IoT large model (hereinafter referred to as “system”) may include an emergency supervision user platform 110, an emergency supervision service platform 120, an emergency supervision management platform 130, an emergency supervision sensor network platform 140, and an emergency supervision object platform 150.

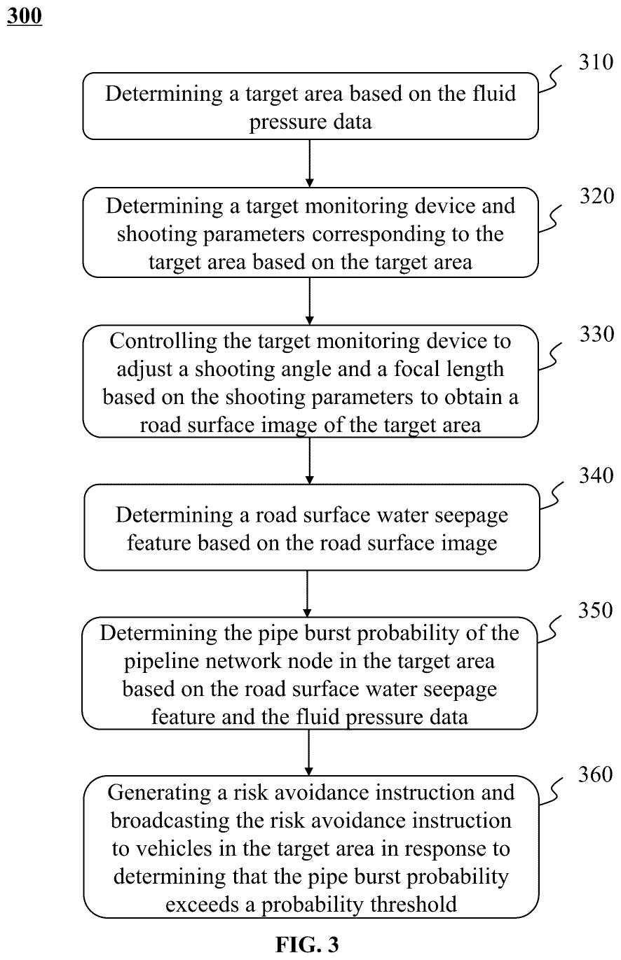

The emergency supervision user platform 110 refers to an interactive platform for emergency management personnel and users. In some embodiments, the emergency supervision user platform 110 may include a server, a gateway, a display, or the like. In some embodiments, the emergency supervision user platform 110 may be communicatively connected to a user terminal (e.g., a cell phone, a computer, a personal digital assistant, etc.) to communicate and transmit data with the user terminal based on commands sent by the emergency supervision management platform 130, e.g., broadcasting a risk avoidance instruction to the user terminal. More descriptions regarding the risk avoidance instruction may refer to FIG. 3 and related descriptions thereof.

The emergency supervision service platform 120 refers to a platform that provides emergency supervision services. In some embodiments, the emergency supervision service platform 120 may be configured as a server for bi-directional data interaction with the emergency supervision user platform 110 and the emergency supervision management platform 130.

The emergency supervision management platform 130 refers to a platform for supervising or managing information related to a city water supply pipeline network. In some embodiments, the emergency supervision management platform 130 may include a processor, a server, a data storage system, a large screen display system, IoT platform software, a communication component (e.g., a communication interface, a gateway), or the like. In some embodiments, the emergency supervision management platform 130 may be a software platform running on the server or in the cloud for processing data and/or information obtained from other platforms (e.g., the emergency supervision service platform 120, the emergency supervision sensor network platform 140). The emergency supervision management platform 130 may execute program instructions based on obtained data, information, and/or corresponding processing results to perform the functions and/or steps described in the present disclosure.

In some embodiments, the emergency supervision management platform 130 is configured to: obtain fluid pressure data; determine a pipe burst probability of a pipeline network node based on the fluid pressure data; and determine a target valve and a valve opening degree of the target valve based on the pipe burst probability, and control the target valve to the valve opening degree.

In some embodiments, the emergency supervision management platform 130 may be configured in the processor and/or the server. The processor and/or server may process data and/or information obtained from other platforms. The processor and/or server may execute program instructions based on such data, information, and/or processing results to perform one or more of the functions described in the present disclosure. In some embodiments, the processor and/or server may include a central processing unit (CPU), an application-specific integrated circuit (ASIC), an application-specific instruction processor (ASIP), or the like, or any combination thereof. In some embodiments, the emergency supervision management platform 130 may include a water supply pipeline emergency supervision module and an emergency supervision data center. The water supply pipeline emergency supervision module may include a data processing model library.

The water supply pipeline emergency supervision module refers to a module for real-time monitoring, early warning, and disposal of the city water supply pipeline network under unexpected circumstances.

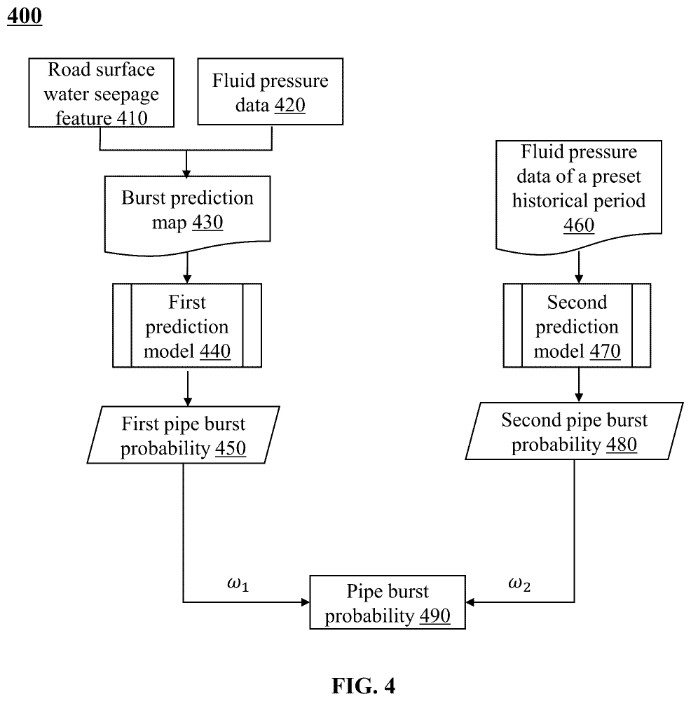

The data processing model library is configured to store a trained data processing large model. In some embodiments, the data processing model library may include a first prediction model, a second prediction model, or the like. More descriptions about the first prediction model and the second prediction model may be found in FIG. 4 and related descriptions thereof.

The emergency supervision data center refers to a data center for collecting, storing data regarding the city water supply pipeline network, e.g., the fluid pressure data and a road surface water seepage feature. In some embodiments, the emergency supervision data center may include MySQL, PostgreSQL, InfluxDB, Prometheus, or the like. In some embodiments, the water supply pipeline emergency supervision module may have bi-directional data interaction with the emergency supervision data center.

The emergency supervision sensor network platform 140 refers to a platform for comprehensive management of sensing information. In some embodiments, the emergency supervision sensor network platform may interact with the emergency supervision management platform and the emergency supervision object platform. In some embodiments, the emergency supervision sensor network platform 140 may include communication devices, servers, various types of gateway devices, etc.

The emergency supervision object platform 150 refers to a platform for various types of entities or systems that are subject to supervision, and is configured to display, manage, and analyze the operation status and data of the supervision object. In some embodiments, the emergency supervision object platform may include a plurality of monitoring devices, sensors, and interaction devices. For example, the emergency supervision object platform may include cameras, pressure sensors, environmental monitoring sensors, smart water meters, and acoustic leak detectors.

In some embodiments, the emergency supervision object platform may include a pipeline network object platform. The pipeline network object platform refers to a platform for collecting data and/or information about the city water supply pipeline network. In some embodiments, the pipeline network object platform may include a water pipe, a valve, a pumping station, a pressure regulating station, or the like.

In some embodiments, the system 100 further includes a storage, etc. The storage is configured to store information and/or data related to the system 100.

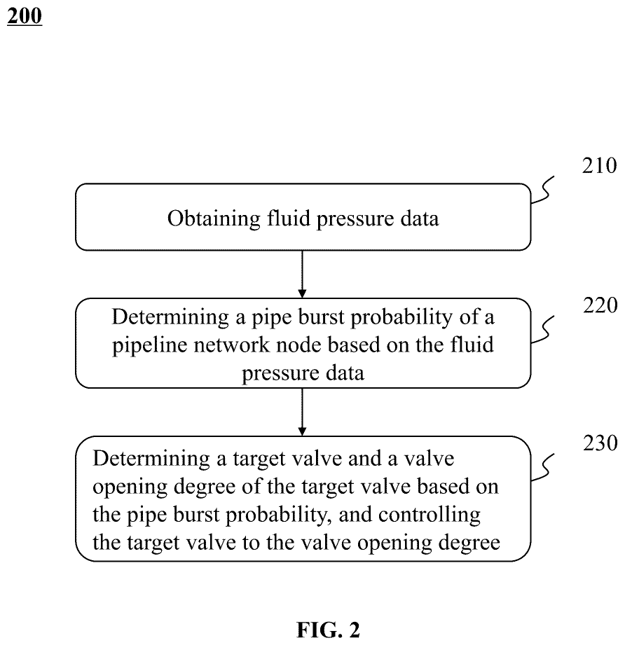

More descriptions of the system 100 may be found in FIG. 2-FIG. 4 and related descriptions thereof.

In some embodiments of the present disclosure, utilizing the system for city lifeline pipeline burst prevention based on the IoT large model to supervise the city water supply pipeline network, monitoring and rapid response to the bursting of a pipeline of the city water supply pipeline network can be realized, and determining the pipe burst probability through intelligent analysis of the monitoring data, and generating risk avoidance tips on the vehicle terminals in the area, can timely eliminate potential safety hazards and effectively improve the safety and reliability of the city water supply pipeline network. At the same time, the combination of automated valve control and operation reduces the investment in manpower inspection and lowers management costs.

FIG. 2 is a flowchart illustrating an exemplary process of a method for city lifeline pipeline burst prevention based on an IoT large model according to some embodiments of the present disclosure. As shown in FIG. 2, the process 200 includes the following steps. In some embodiments, the process 200 may be executed by the emergency supervision management platform or the processor. The following example illustrates execution by a processor.

Step 210, obtaining fluid pressure data.

The fluid pressure data refers to the water pressure at a plurality of pipeline network nodes in the city water supply pipeline network.

The pipeline network nodes refer to key nodes in the city water supply pipeline network. For example, the key nodes may include water pipes, connection points of water pipes, branching points, turning points, or control points in the city water supply pipeline network.

In some embodiments, the plurality of pipeline network nodes of the city water supply pipeline network may be provided with fluid pressure monitoring devices, e.g., sensors, pressure gauges, or the like. The processor may obtain the fluid pressure data based on monitoring data from the fluid pressure monitoring devices.

Step 220, determining a pipe burst probability of a pipeline network node based on the fluid pressure data.

The pipe burst probability may indicate the likelihood of a water pipe bursting at the pipeline network node. For example, the higher the pipe burst probability is, the greater the likelihood of the water pipe bursting at the pipeline network nodes is.

In some embodiments, the processor may determine the pipe burst probability of the pipeline network node based on the fluid pressure data.

In some embodiments, for a pipeline network node, the processor may determine a water pressure for the pipeline network node based on the fluid pressure data, and then calculate a water pressure difference value between the water pressure and a pressure threshold corresponding to the pipeline network node. If the water pressure difference value is positive, it may be determined that there is a pipe burst risk at this pipeline network node. In some embodiments, the pipe burst probability is positively correlated to the water pressure difference value, and the greater the water pressure difference value is, the greater the pipe burst probability is.

If the water pressure difference value is negative, it may be determined that the pipe burst risk at the pipeline network node is low or does not exist, and the pipe burst probability may be set to 0.

The pressure threshold refers to a critical value for assessing the likelihood that the water pressure at the pipeline network node will cause the pipe to burst. In some embodiments, the processor may obtain the pressure threshold corresponding to each pipeline network node from the storage.

In some embodiments, the pressure threshold may be set by a person skilled based on experience.

More descriptions regarding the determination of the pipe burst probability may be found in FIG. 3 and FIG. 4 and related descriptions thereof.

Step 230, determining a target valve and a valve opening degree of the target valve based on the pipe burst probability, and controlling the target valve to the valve opening degree.

The target valve refers to a valve that is used to control the water pressure at a pipeline network node where the pipe burst probability is greater than 0. In some embodiments, a valve with the closest connection distance to the pipeline network node with the pipe burst probability greater than 0 may be identified as the target valve. In some embodiments, the target valve includes an electrically operated valve, e.g., an angle-stroke electrically operated valve, a straight-stroke electrically operated valve.

The valve opening degree refers to the degree of opening of the valve.

In some embodiments, the processor may determine the valve opening degree of the target valve based on the pipe burst probability. For example, the valve opening degree may be positively correlated to the pipe burst probability, and the greater the pipe burst probability is, the greater the valve opening degree is.

In some embodiments, the processor may be communicatively connected to the target valve or a controller of the target valve, and control the target valve opening or closing to the valve opening degree via the communication.

In some embodiments, in response to determining that the pipe burst probability exceeds a probability threshold, the processor may determine supply pressure adjustment parameters based on the pipe burst probability, the supply pressure adjustment parameters including a target water pump, a target supply pressure, and a target water pump speed; and adjust a water pump speed of the target water pump to the target water pump speed based on the supply pressure adjustment parameters to regulate a supply pressure of the pipeline network to the target supply pressure.

The probability threshold refers to a critical probability for assessing the bursting of a pipeline network node. In some embodiments, the processor may obtain the probability threshold corresponding to the pipeline network node from the storage.

In some embodiments, the probability threshold may be set by a person skilled based on experience.

The supply pressure adjustment parameters refer to parameters used to adjust the supply pressure of the water pump. In some embodiments, the supply pressure adjustment parameters may include at least one of a target water pump, a target supply pressure, and a target water pump speed, etc.

The target water pump refers to a water pump that is directly connected to the pipeline network node that has a pipe burst probability greater than 0. In some embodiments, the target water pump may be determined by querying a first preset table or a second preset table.

More descriptions regarding the first preset table and the second preset table may be found elsewhere in the present disclosure.

The target supply pressure refers to the supply pressure required when the pipe burst probability of the target water pump drops below the probability threshold. In some embodiments, the target supply pressure may be determined based on the pipe burst probability by querying the first preset table or the second preset table.

The target water pump speed refers to the water pump speed required when the pipe burst probability of the target water pump drops below the probability threshold. In some embodiments, the target water pump speed may be determined based on the pipe burst probability by querying the first preset table or the second preset table.

In some embodiments, the processor may determine the supply pressure adjustment parameters based on the pipe burst probability in a variety of ways. For example, the processor may determine the supply pressure adjustment parameters based on the first preset table.

The first preset table reflects the corresponding relationship between each pipeline network node distributed in the city water supply pipeline network, the pipe burst probability corresponding to the pipeline network node, and the target water pump, target supply pressure, and the target water pump speed in the supply pressure adjustment parameters. In some embodiments, the processor may determine, based on a pipeline network node with a pipe burst probability greater than 0, the target water pump, the target supply pressure, and the target water pump speed corresponding to the pipeline network node by querying the first preset table.

In some embodiments, the first preset table may be set by a person skilled based on experience or historical data. For example, the first preset table may be constructed with historical target supply pressures and historical target water pump speeds corresponding to the target water pump at the pipeline network node with good prevention effects (e.g., no more bursts) in the historical data. In some embodiments, the pipe burst probability may be negatively correlated to the target supply pressure and the target water pump speed. For example, the higher the pipe burst probability is, the lower the target supply pressure is, and the lower the target water pump speed is.

In some embodiments, the supply pressure adjustment parameters may be related to at least one of a type of the target area, an area radius, and a traffic flow of the target area, etc.

The target area refers to an area associated with the pipeline network node that requires further monitoring. More descriptions regarding the target area may be found in FIG. 3 and related descriptions thereof.

The type of the target area may reflect the traffic flow, the vehicle speed, and other information about the target area. For example, the type of the target area may be a highway, a main road, an intersection.

In some embodiments, the processor may obtain a distribution map of the city water supply pipeline network from the storage and determine the type of the target area from the distribution map of the city water supply pipeline network. The distribution map of the city water supply pipeline network is a specialized drawing showing the spatial layout and connection relationship of water sources, the pipeline network nodes, pumping stations, and ancillary facilities in the city water supply pipeline network. In some embodiments, the distribution map of the city water supply pipeline network includes location information of the plurality of pipeline network nodes, road information, or the like.

The area radius refers to the radius of the target area established with the monitoring center as the center. More descriptions regarding the area radius and the monitoring center may be found in FIG. 3 and related descriptions thereof.

In some embodiments, the traffic flow of the target area is related to the type of the target area.

In some embodiments, the processor may also determine the traffic flow of the target area based on a road surface image. For example, the processor may determine the count of vehicles passing through per unit time in the road surface image to determine the traffic flow of the target area.

More descriptions regarding the road surface image may be found in FIG. 3 and related descriptions thereof.

In some embodiments, the processor may determine the supply pressure adjustment parameters via the second preset table.

The second preset table reflects the corresponding relationship between (the pipeline network nodes distributed in the city water supply pipeline network, the pipe burst probability corresponding to the pipeline network node, the type of the target area in which the pipeline network node is located, the area radius, and the traffic flow of the target area), and (the target water pump, the target supply pressure, and the target water pump speed of the supply pressure adjustment parameters). The processor may determine, based on the pipeline network node with a pipe burst probability greater than 0, the pipe burst probability, the type of the target area in which the pipeline network node is located, the area radius, and the traffic flow of the target area, by querying the second preset table, the target water pump, the target supply pressure, and the target water pump speed corresponding to the pipeline network node with the pipe burst probability greater than 0.

In some embodiments, the second preset table may be set by a person skilled based on experience or the historical data. For example, the second preset table may be constructed with the historical target supply pressures and the historical target water pump speeds corresponding to the target water pump at the pipeline network nodes with good preventive effect (e.g., no more bursts) in the historical data, combining with the type of the historical target area in which the target water pump is located, the historical area radius, and the traffic flow of the historical target area.

According to some embodiments of the present disclosure, when adjusting the target supply pressure of the target water pump corresponding to the pipeline network node with a pipe burst risk, taking into account the type of the area in which the pipeline network node is located, the area radius, and the traffic flow of the area, it is possible to adjust the supply pressure of the target water pump more flexibly for different areas. For example, in high-risk areas (e.g., main roads, areas with high traffic flow), the supply pressure of the target water pump may be reduced as early as possible (for example, when the pipe burst probability is at a low value) to avoid the harm and losses caused by a pipe burst. In low-risk areas (e.g., branch roads, areas with low traffic flow), the reduction of the supply pressure of the target water pump may be delayed (for example, when the pipe burst probability is at a high value) to avoid the impact of reducing the water pump supply pressure on the water use of the downstream urban residents. It achieves dynamic adjustment of the target supply pressure, strengthens protection in high-risk areas, and ensures efficient operation of the city water supply pipeline network in low-risk areas.

In some embodiments, the processor may be communicatively connected with the target water pump or the controller of the target water pump, and adjust the water pump speed of the target water pump to the target water pump speed based on the determined supply pressure adjustment parameters, to adjust the supply pressure of the pipeline network to the target supply pressure.

According to some embodiments of the present disclosure, by automatically adjusting the supply pressure and the water pump speed of the target water pump corresponding to the pipeline network node when the pipe burst probability of the pipeline network node exceeds the probability threshold, the required reduction value of the supply pressure of the target water pump can be precisely controlled to avoid the risk of hydraulic shock in the pipeline network caused by sudden and drastic reductions of the supply pressure. In addition, setting different supply pressures and water pump speeds of the target water pumps for different pipeline network nodes and pipe burst probabilities can enhance the flexibility of pressure adjustment. This approach avoids an excessive reduction in the supply pressure of the target water pump, which could affect the water usage of downstream city residents, while still allowing for a decrease in the pressure of the target water pump.

According to some embodiments of the present disclosure, by analyzing the fluid pressure data in the city water supply pipeline network to determine the pipe burst probability at each pipeline network node, and then determining the target valve and its opening degree based on the pipe burst probability, the target valve that need to be controlled can be quickly and accurately located, and the valve opening degree is accurately controlled to minimize impact on the water use of the city residents when bursting occurs.

FIG. 3 is a flowchart illustrating an exemplary process of generating a risk avoidance instruction according to some embodiments of the present disclosure. As shown in FIG. 3, the process 300 includes the following steps. In some embodiments, process 300 may be executed by the processor.

Step 310, determining a target area based on the fluid pressure data.

In some embodiments, the processor may take the area composed of a plurality of pipeline network nodes, in the fluid pressure data, with the water pressure greater than a pressure threshold as the target area.

In some embodiments, the processor may determine a monitoring center and an area radius based on the fluid pressure data and the pressure threshold, and determine the target area based on the monitoring center and the area radius.

More descriptions regarding the pressure threshold may be found in FIG. 2 and related descriptions thereof.

The monitoring center refers to a key monitoring point in the target area.

In some embodiments, for each of the plurality of pipeline network nodes in the target area, the processor may determine the water pressure of the pipeline network node based on the fluid pressure data and obtain the pressure threshold corresponding to the pipeline network node from the storage to determine the water pressure difference value between the water pressure and the pressure threshold.

In some embodiments, the processor selects, from a plurality of water pressure difference values of the plurality of pipeline network nodes, a water pressure difference value greater than 0 and determines a plurality of pipeline network nodes with the water pressure difference value greater than 0 as reference pipeline network nodes. In some embodiments, the processor may construct a vector to be clustered with the water pressure difference value and the corresponding location coordinate of each reference pipeline network node. In some embodiments, the location coordinate of the pipeline network node may be obtained from the distribution map of the city water supply pipeline network in the storage.

In some embodiments, the processor may determine a plurality of clustering centers by clustering a plurality of vectors to be clustered corresponding to the plurality of reference pipeline network nodes using a clustering algorithm. The clustering algorithms may include, but are not limited to, K-Means clustering and/or density-based spatial clustering of applications with noise (DBSCAN), etc.

In some embodiments, the processor may select, from the plurality of clustering centers, clustering centers with water pressure difference values that are greater than the difference threshold as candidate clustering centers, and then sort the candidate clustering centers according to the size of the water pressure difference values, and determine the location coordinate of the pipeline network node corresponding to the candidate clustering center with the largest water pressure difference value as the monitoring center. The difference threshold refers to a critical water pressure difference value at which a clustering center may be considered as a candidate clustering center.

In some embodiments, the difference threshold may be set by a person skilled based on experience.

In some embodiments, the processor may determine the area radius based on the fluid pressure data of the monitoring center. For example, the area radius may be positively correlated to the water pressure difference value of the monitoring center, with the greater the water pressure difference value of the monitoring center, the greater the area radius.

In some embodiments, the processor may determine an area of the monitoring center that is covered by the area radius as the target area.

According to some embodiments of the present disclosure, by determining the plurality of pipeline network nodes with the water pressure difference value greater than 0 based on the water pressure and the pressure threshold of the pipeline network node, constructing clustering vectors based on the water pressure difference values and location coordinates of these pipeline network nodes, determining the clustering center through the clustering algorithm, determining the monitoring center based on the clustering center, determining the area radius based on the water pressure difference value corresponding to the monitoring center, and determining the target area based on the monitoring center and the area radius, the target area can be determined more reasonably and accurately, and monitoring resources (e.g., monitoring devices) within the target area can be used more reasonably, while improving monitoring effectiveness, for example, obtaining more comprehensive and accurate road surface images.

More descriptions regarding the fluid pressure data may be found in FIG. 2 and the related description thereof.

Step 320, determining a target monitoring device and shooting parameters corresponding to the target area based on the target area.

The target monitoring device refers to a monitoring device in the target area. In some embodiments, the target monitoring device may include a camera, a video recorder, or the like. In some embodiments, the processor may determine a monitoring device that is located within the target area as the target monitoring device.

The shooting parameter refers to a parameter involved in the monitoring device performing the monitoring. In some embodiments, the shooting parameter includes at least one of a target shooting angle, a target focal length, etc.

The target shooting angle refers to a shooting angle of the target monitoring device when taking a picture of the target area. In some embodiments, the processor may determine the target shooting angle based on an initial shooting angle and a deflection angle. The initial shooting angle is a preset shooting angle of the target monitoring device, and the deflection angle is the angle at which, in order to shoot the target area, the target monitoring device needs to be deflected from the initial shooting angle. In some embodiments, the processor may determine a virtual line based on the location coordinate of the monitoring center and the location coordinate of the target monitoring device, and then create a virtual straight line based on the direction of the lens of the target monitoring device when the target monitoring device is at the initial shooting angle, and determine the angle between the virtual line and the virtual straight line as the deflection angle. In some embodiments, the processor may obtain the location coordinate of the target monitoring device from the storage, for example, a city monitoring device distribution map in the storage. The city monitoring device distribution map includes information such as the type of the monitoring device and the distribution location.

The target focal length refers to a focal length used by the target monitoring device when taking pictures of the target area. In some embodiments, the processor may determine the target focal length based on the shooting distance between the target monitoring device and the monitoring center of the target area. In some embodiments, the target focal length is positively correlated to the shooting distance, e.g., the farther away the shooting distance is, the longer the target focal length is.

In some embodiments, the processor may employ an optical ranging technique to determine the shooting distance between the target monitoring device and the monitoring center of the target area based on the captured monitoring image of the target area, e.g., phase ranging, similar triangles.

Step 330, controlling the target monitoring device to adjust a shooting angle and a focal length based on the shooting parameters to obtain a road surface image of the target area.

The road surface image refers to a monitoring image of the road surface in the target area.

In some embodiments, the processor may control the lens of the target monitoring device to be deflected at the deflection angle based on the target shooting angle and the initial shooting angle, so that the target monitoring device photographs the target area at the target shooting angle.

In some embodiments, the processor may control the target monitoring device to photograph the target area at the target focal length.

In some embodiments, the processor may perform an image fusion on a plurality of monitoring images obtained by a plurality of target monitoring devices in the target area to form a road surface image covering the target area. In some embodiments, the manner of the image fusion may include, but is not limited to, Alpha fusion, Poisson fusion, or the like.

Step 340, determining the road surface water seepage feature based on the road surface image.

The road surface water seepage feature refers to a feature related to road surface water seepage in the target area, for example, a seepage location, a seepage flow.

In some embodiments, the processor may determine the road surface water seepage feature through an image recognition technology. The image recognition technology includes, but is not limited to, scale-invariant feature transform (SIFT) algorithms, deep learning techniques, image segmentation techniques, etc.

The seepage location refers to a location of the seepage point on the road surface. In some embodiments, the processor may determine the seepage location through the image recognition technology.

The seepage flow refers to the water output volume of the seepage point in a unit of time. In some embodiments, the processor may obtain images taken continuously by the target monitoring device in a unit of time, and determine the seepage flow based on the continuously captured images using the image recognition technology.

Step 350, determining the pipe burst probability of the pipeline network node in the target area based on the road surface water seepage feature and the fluid pressure data.

In some embodiments, the processor may determine, based on the seepage location, the pipeline network node corresponding to the seepage location, and then determine, based on the fluid pressure data, the water pressure of the pipeline network node corresponding to the seepage location, and then determine, based on the water pressure, the water pressure difference value of the pipeline network node corresponding to the seepage location.

More descriptions regarding the water pressure difference value may be found in FIG. 2 and related descriptions thereof.

In some embodiments, the processor may normalize the seepage flow and the water pressure difference value, and perform a weighted sum on the normalized seepage flow and the normalized water pressure difference value to obtain a score of the pipe burst probability.

Exemplarily, the score of the pipe burst probability may also be obtained based on the following formula (1):

$$p = {k}_{1} \times A + {k}_{2} \times B \qquad ( 1 )$$

In formula (1), p represents the score of the pipe burst probability, A represents the normalized seepage flow, B represents the normalized water pressure difference value, k₁ and k₂ are coefficients greater than 0, the value of the coefficients k₁ and k₂ may be preset based on prior experience.

In some embodiments, the pipe burst probability is positively correlated to the score of pipe burst probability, and the higher the score of pipe burst probability is, the higher the pipe burst probability is.

Step 360, generating a risk avoidance instruction and broadcasting the risk avoidance instruction to vehicles in the target area in response to determining that the pipe burst probability exceeds the probability threshold.

More descriptions regarding the probability threshold may be found in FIG. 2 and related descriptions thereof.

The risk avoidance instruction refers to a safety control instruction that instructs a vehicle, pedestrian, etc., to avoid a hazard. In some embodiments, the risk avoidance instruction includes a risk avoidance location.

The risk avoidance location refers to a location to be avoided. In some embodiments, the processor may use the seepage location as the risk avoidance location.

In some embodiments, the risk avoidance instruction further includes a broadcast intensity, and the broadcast intensity is related to the type of the target area and/or the type of the vehicles.

The broadcast intensity reflects the urgency of the execution of the risk avoidance instruction. In some embodiments, the broadcast intensity includes at least one of a broadcasting frequency, a broadcasting duration, etc., of the broadcast.

In some embodiments, the processor may perform the broadcasting of the risk avoidance instruction in various ways. For example, the broadcasting of the risk avoidance instructions is performed via a voice announcement device in the target monitoring device. As another example, the broadcasting is performed via a drone in an area over the target area. As still another example, the broadcasting is performed via an in-vehicle radio device (e.g., a car radio).

The types of the vehicles include normal vehicles and special vehicles. The special vehicles refer to vehicles with special properties. The special vehicles include, but are not limited to, buses, school buses, hazardous materials transportation vehicles, etc. The normal vehicles refer to vehicles other than the special vehicles. In some embodiments, the processor may obtain a traffic data image within the target area and a surrounding area (e.g., within 2 kilometers outside of the target area) based on the monitoring devices within the target area and identify the type of all the vehicles within the traffic data image using the image recognition technology.

More descriptions regarding the type of target area may be found in FIG. 2 and related descriptions thereof.

In some embodiments, the processor may determine the broadcast intensity in various ways. For example, the processor may determine the broadcast intensity based on a third preset table.

The third preset table reflects the corresponding relationship between the type of the target area, the presence or absence of a special vehicle, and the broadcasting frequency and broadcasting duration of the broadcast. In some embodiments, the processor may determine the broadcast frequency and duration of the broadcast by querying the third preset table based on the type of the target area and the presence or absence of the special vehicle in the target area and the surrounding area. For example, if the type of the target area is a highway or a main road, the processor may reduce the broadcasting frequency and broadcasting duration of the broadcast to avoid distracting the driver. As another example, if a special vehicle exists in the target area and the surrounding area, the processor may increase the broadcasting frequency to alert the driver of the special vehicle as much as possible.

In some embodiments, the third preset table may be set by a person skilled based on experience.

According to some embodiments of the present disclosure, according to the type of target area and the type of the vehicles in the target area and the surrounding area, the broadcast intensity of the risk avoidance instruction (e.g., the broadcasting frequency and the broadcasting duration) can be dynamically adjusted. This ensures the effectiveness of safety warnings while reducing distractions to drivers, achieving precise alerts for specific types of target areas or special vehicles.

According to some embodiments of the present disclosure, by combining the fluid pressure data and the road surface water seepage feature to analyze the pipe burst probability of the pipeline network node, the high-risk area (i.e., the target area) can be dynamically determined, and the accuracy of determining the pipe burst probability can be improved; at the same time, real-time broadcasting to vehicles in the target area and surrounding areas in combination with the risk avoidance instruction can form a closed loop of “monitoring-analysis-warning-avoidance”. Compared to the traditional monitoring and warning time lag caused by manual inspection, some embodiments in the present disclosure can improve the efficiency of monitoring and warning of the pipe burst probability in the pipeline network and also enhance the safety of vehicles or personnel and property. In addition, actively prompting vehicles in high-risk areas to detour or brake can reduce traffic accidents or economic losses caused by pipe bursts, and achieve a technological upgrade in the safety protection of the city water supply pipeline network from passive response to active avoidance.

It should be noted that the foregoing description of the process 300 is intended to be exemplary and illustrative only, and does not limit the scope of application of the present disclosure. For a person skilled in the art, various corrections and changes may be made to the process 300 under the guidance of the present disclosure. However, these corrections and changes remain within the scope of the present disclosure. For example, the processor may dynamically adjust the shooting parameters based on the target area in conjunction with the location of the target area, lighting conditions, or the like.

FIG. 4 is an exemplary schematic diagram for determining a pipe burst probability according to some embodiments of the present disclosure.

In some embodiments, the emergency supervision management platform is further configured to: construct a burst prediction map 430 based on the road surface water seepage feature 410 and the fluid pressure data 420; determine a first pipe burst probability 450 of the pipeline network node based on the burst prediction map 430 using a first prediction model 440, wherein the first prediction model is a machine learning model; determine a second pipe burst probability 480 of the pipeline network node based on fluid pressure data of a preset historical period 460 using a second prediction model 470; and determine the pipe burst probability 490 of the pipeline network node by performing weighted fusion on the first pipe burst probability 450 and the second pipe burst probability 480.

The burst prediction map refers to a knowledge map that represents the distribution of the potential risk of pipe bursts at each pipeline network node.

In some embodiments, the emergency supervision management platform may construct the burst prediction map based on the road surface water seepage feature and the fluid pressure data. More descriptions regarding the road surface water seepage feature and fluid pressure data may be found in FIG. 2 and related descriptions thereof.

In some embodiments, the burst prediction map may be composed of at least one node and at least one edge, with each node having corresponding node characteristics.

In some embodiments, the node includes a pipeline network node, a seepage node. More descriptions regarding the pipeline network node may be found in step 210 and related descriptions thereof. The seepage node corresponds to the seepage location in the road surface water seepage feature.

In some embodiments, the node characteristics of the pipeline network node may include the fluid pressure data corresponding to the node and a water pipe material. The node characteristics of the seepage node may include the road surface water seepage feature.

In some embodiments, the water pipe material may be obtained by querying the construction drawings of the city water supply pipeline network or the list of materials in the as-built acceptance report.

In some embodiments, the edges of the burst prediction map include a first class of edges and a second class of edges. The first class of edges is used to connect the pipeline network nodes. In some embodiments, if a physical connection relationship exists between the pipeline network nodes, the first class of edge is present between them. The physical connection relationship refers to the topological relationship between the pipeline network nodes that are physically connected directly or through pipeline ancillary equipment (e.g., valves, tees, flanges) and form a continuous water flow path. Edge characteristics of the first class of edges includes a pressure difference between two pipeline network nodes. The second class of edges is used to connect the pipeline network node and the seepage node. In some embodiments, the second class of edges exists between the seepage node and the pipeline network node if the physical distance between the two nodes is less than a distance threshold. The distance threshold may be preset by a person skilled in the art based on experience. The edge characteristics of the second class of edges includes the physical distance.

The first pipe burst probability refers to a parameter that characterizes the possibility of pipe bursting predicted by fusing the spatial structure of the pipeline network.

In some embodiments, the emergency supervision management platform may determine the first pipe burst probability at the pipeline network node based on the burst prediction map through the first prediction model.

The first prediction model refers to a model for predicting the first pipe burst probability at the pipeline network node. In some embodiments, the first prediction model is a machine learning model. For example, the first prediction model may include any one or a combination of one or more of a Deep Neural Network (DNN) model, a Convolutional Neural Network (CNN) model, other customized models, or the like.

In some embodiments, an input of the first prediction model may be the burst prediction map, and an output of the first prediction model may be the first pipe burst probability of the pipeline network node.

In some embodiments, the first prediction model may be obtained by training an initial first prediction model with a plurality of first training samples with first labels. The first training sample may include the burst prediction map corresponding to a first historical time point. The first label may include the actual occurrence of pipe bursts at the pipeline network node during a time period from the first historical time point to a second historical time point under the first training sample. The first historical time point precedes the second historical time point. In some embodiments, for a pipeline network node that experience a pipe burst during the time period from the first historical time point to the second historical time point, the longer the time interval between a time of occurrence and the first historical time point, the lower the value of the first pipe burst probability of the pipeline network node, and for a pipeline network node that has not experienced the pipe burst, the first pipe burst probability is 0.

In some embodiments, the first training sample and the first label may be obtained based on the historical data.

In some embodiments, the emergency supervision management platform may input the plurality of first training samples with the first labels into the initial first prediction model, construct a loss function through the first labels and the output results of the initial first prediction model, and iteratively update parameters of the initial first prediction model based on the loss function by gradient descent or other means. When a preset condition is satisfied, the model training is completed, and a trained first prediction model is obtained. The preset condition may be that the loss function converges, the count of iterations reaches a threshold, etc.

The second pipe burst probability refers to a parameter that characterizes the likelihood of pipeline bursting predicted by fusing the time series of the pipeline network.

In some embodiments, the emergency supervision management platform may determine, based on fluid pressure data from a preset historical period, the second pipe burst probability at the pipeline network node through the second prediction model.

The preset historical period refers to a time interval with a preset range of duration. In some embodiments, the preset historical period may be a period of time prior to the current moment. In some embodiments, the preset historical period may be set by the experience of a person skilled in the art.

In some embodiments, a time length of the preset historical period is related to the road surface water seepage feature and the water seepage threshold.

The water seepage threshold refers to a parameter that determines whether the seepage flow is normal. In some embodiments, the water seepage threshold may be set by the experience of a person skilled in the art.

In some embodiments, the greater the difference between the seepage flow of the road surface water seepage feature and the water seepage threshold, the shorter the time length of the preset historical period.

In some embodiments of the present disclosure, the time length of the preset historical period correlates to the road surface water seepage feature and the water seepage threshold. When the difference between the seepage flow of the road surface water seepage feature and the water seepage threshold increases, it indicates that the degree of road surface water seepage has intensified, and the pipe burst risk has significantly increased. At this time, the time length of the preset historical period may be shortened accordingly to enhance the computational efficiency, accelerate the system response speed, and realize more timely warning and disposal.

The second prediction model refers to a model used to predict the second pipe burst probability of the pipeline network node. In some embodiments, the second prediction model is the machine learning model. For example, the second prediction model may include any one or a combination of one or more of a Deep Neural Network (DNN) model, a Convolutional Neural Network (CNN) model, another customized model, or the like.

In some embodiments, an input of the second prediction model may be the fluid pressure data of the pipeline network node at the preset historical period, and an output of the second prediction model may be the second pipe burst probability of the pipeline network node.

In some embodiments, the second prediction model may be obtained by training an initial second prediction model with a plurality of second training samples with second labels. The second training sample may include the fluid pressure data of a sample pipeline network node for a first preset period in the historical data. The second label may include actual pipe bursts of the sample pipeline network node during a second preset period after the first preset period. If a pipe burst occurs, the second label takes the value of 1; if the pipe burst does not occur, the second label takes the value of 0. The time length of the first preset period is the same as the time length of the preset historical period, and the second preset period may be set by a person skilled in the art based on experience.

In some embodiments, the second training sample and the second label may be obtained based on the historical data.

The training process of the second prediction model is similar to the training process of the first prediction model. More descriptions regarding the training process of the first prediction model may be found elsewhere in the present disclosure.

In some embodiments, the emergency supervision management platform may determine the pipe burst probability of the pipeline network node by performing a weighted fusion of the first pipe burst probability and the second pipe burst probability of the pipeline network node. More descriptions regarding the pipe burst probability may be found in step 220 and related description thereof.

In some embodiments, the weighted fusion can be calculated by formula (2) shown below:

$$P = {ω}_{1} \times {P}_{1} + {ω}_{2} \times {P}_{2} \qquad ( 2 )$$

In formula (2), P represents the pipe burst probability of the pipeline network node; P₁ represents the first pipe burst probability of the pipeline network node; ω₁ represents the weight of the first pipe burst probability; P₂ represents the second pipe burst probability of the pipeline network node; ω₂ represents the weight of the second pipe burst probability; and ω₁ and ω₂ are satisfied ω₁+ω₂=1.

In some embodiments, in the weighted fusion, the weight of the second pipe burst probability is related to a area radius. More descriptions regarding the area radius may be found in step 310 and related descriptions thereof.

In some embodiments, the larger the area radius is, the greater the weight of the second pipe burst probability is.

In some embodiments of the present disclosure, the weight of the second pipe burst probability is correlated with the area radius. As the area radius increases, the load on the monitoring device may increase accordingly, and given the non-uniformity of the spatial distribution of the monitoring devices, the effectiveness of identifying the road surface water seepage feature may subsequently decrease. Therefore, increasing the weight of the second pipe burst probability predicted by fusing time series helps to improve the reliability of the prediction of the pipe burst probability.

In some embodiments of the present disclosure, by constructing the burst prediction map and fusing the fluid pressure data, the first prediction model models and analyzes the pipeline network structure in a spatial dimension, and outputs the first pipe burst probability that characterizes the spatial risk distribution. Meanwhile, the second prediction model captures the pressure dynamic evolution law from a time dimension based on the fluid pressure data in a time series of the preset historical period, and outputs a second pipe burst probability that characterizes the time dimension. Ultimately, the processor generates the combined pipe burst probability of the pipeline network node by performing the weighted fusion on the above predictions in both temporal and spatial dimensions (i.e., the first pipe burst probability and the second pipe burst probability). This spatio-temporal coupling prediction manner effectively overcomes the limitations of the traditional single-dimensional (i.e., only spatial or only temporal) assessment model, and comprehensively utilizes the information on the topology of the pipeline network and the characteristics of the historical pressure changes, which significantly improves the accuracy and reliability of the prediction of the pipe burst probability.

The basic concepts have been described above. Obviously, for the person skilled in the art, the above detailed disclosure is merely an example, and does not constitute a limitation of the present disclosure. Although not explicitly described herein, various modifications, improvements, and corrections to the present disclosure may occur to a person skilled in the art. Such modifications, improvements, and corrections are suggested in the present disclosure, so such modifications, improvements, and corrections still belong to the spirit and scope of the exemplary embodiments of the present disclosure.

At the same time, the present disclosure uses specific words to describe the embodiments of the present disclosure. For example, “one embodiment,” “an embodiment,” and/or “some embodiments” mean a certain feature, structure, or characteristic associated with at least one embodiment of the present disclosure. Therefore, it should be emphasized and noted that two or more references to “an embodiment” or “one embodiment” or “an alternative embodiment” in various places in the present disclosure are not necessarily referring to the same embodiment. In addition, certain features, structures, or characteristics of the one or more embodiments of the present disclosure may be combined as appropriate.

In addition, unless explicitly stated in the claims, the order of processing elements and sequences described in the present disclosure, the use of alphanumerics, or the use of other names is not intended to limit the order of the processes and methods of the present disclosure. Although the above disclosure discusses through various examples what is currently considered to be a variety of useful embodiments of the disclosure, it is to be understood that such detail is solely for illustration, and that the appended claims are not limited to the disclosed embodiments, but, on the contrary, are intended to cover modifications and equivalent arrangements that are within the spirit and scope of the disclosed embodiments. For example, although the implementation of various components described above maybe embodied in a hardware device, it may also be implemented as a software-only solution, e.g., an installation on an existing server or mobile device.

Similarly, it should be noted that, in order to simplify the expressions disclosed in the present disclosure and thus help the understanding of one or more embodiments, in the foregoing description of the embodiments of the present disclosure, various features may sometimes be combined into one embodiment, accompanying drawing, or description. However, this method of disclosure does not imply that the subject matter of the disclosure requires more features than are recited in the claims. Rather, claimed subject matter may lie in less than all features of a single foregoing disclosed embodiment.

Some embodiments use numbers to describe quantities of ingredients and attributes, it should be understood that such numbers used to describe the embodiments, in some examples, use the modifiers “about”, “approximately”, or “substantially” to retouch. Unless stated otherwise, “about”, “approximately”, or “substantially” means that a variation of +20% is allowed for the stated number. Accordingly, in some embodiments, the numerical parameters used in the specification and claims are approximate values, and the approximate values may be changed according to characteristics required by individual embodiments. In some embodiments, the numerical parameters should take into account the specified significant digits and use a general digit reservation method. Notwithstanding that the numerical fields and parameters used in some embodiments of the present disclosure to confirm the breadth of their ranges are approximations, in specific embodiments, such numerical values are set as precisely as practicable.

For each patent, patent application, patent application publication, and other material, such as an article, a book, a specification, a publication, a document, etc., cited in the present disclosure, the entire contents of which are hereby incorporated into the present disclosure by reference. Application history documents that are inconsistent with or conflict with the contents of the present disclosure are excluded, as are documents (currently or hereafter appended to the present disclosure) limiting the broadest scope of the claims of the present disclosure. It should be noted that, if there is any inconsistency or conflict between the descriptions, definitions, and/or use of terms in the accompanying materials of the present disclosure and the contents of the present disclosure, the descriptions, definitions, and/or use of terms in the present disclosure shall prevail. Finally, it should be understood that the embodiments described in the present disclosure are only used to illustrate the principles of the embodiments of the present disclosure. Other variations may also belong to the scope of the present disclosure. Accordingly, by way of example and not limitation, alternative configurations of the embodiments of the present disclosure may be considered consistent with the instructions of the present disclosure. Correspondingly, the embodiments of the present disclosure are not limited to the embodiments expressly introduced and described in the present disclosure.

What is claimed is:

1. A system for city lifeline pipeline burst prevention based on an Internet of Things (IoT) large model, comprising an emergency supervision management platform, wherein the emergency supervision management platform is configured to:
obtain fluid pressure data;
determine a pipe burst probability of a pipeline network node based on the fluid pressure data; and
determine a target valve and a valve opening degree of the target valve based on the pipe burst probability, and control the target valve to the valve opening degree.

2. The system of claim 1, wherein the emergency supervision management platform is further configured to:
determine a target area based on the fluid pressure data;
determine a target monitoring device and shooting parameters corresponding to the target area based on the target area;
control the target monitoring device to adjust a shooting angle and a focal length based on the shooting parameters to obtain a road surface image of the target area;
determine a road surface water seepage feature based on the road surface image;
determine the pipe burst probability of the pipeline network node in the target area based on the road surface water seepage feature and the fluid pressure data; and
generate a risk avoidance instruction and broadcast the risk avoidance instruction to vehicles in the target area in response to determining that the pipe burst probability exceeds a probability threshold.

3. The system of claim 2, wherein the emergency supervision management platform is further configured to:
determine a monitoring center and an area radius based on the fluid pressure data and a pressure threshold; and
determine the target area based on the monitoring center and the area radius.

4. The system of claim 2, wherein the risk avoidance instruction includes a broadcast intensity, and the broadcast intensity is related to a type of the target area and/or a type of the vehicles.

5. The system of claim 2, wherein the emergency supervision management platform is further configured to:
construct a burst prediction map based on the road surface water seepage feature and the fluid pressure data;
determine a first pipe burst probability of the pipeline network node based on the burst prediction map using a first prediction model, wherein the first prediction model is a machine learning model;
determine a second pipe burst probability of the pipeline network node based on fluid pressure data of a preset historical period using a second prediction model; and
determine the pipe burst probability of the pipeline network node by performing weighted fusion on the first pipe burst probability and the second pipe burst probability.

6. The system of claim 5, wherein a time length of the preset historical period is related to the road surface water seepage feature and a water seepage threshold.

7. The system of claim 6, wherein in the weighted fusion, a weight of the second pipe burst probability is related to an area radius.

8. The system of claim 1, wherein the emergency supervision management platform is further configured to:
in response to determining that the pipe burst probability exceeds a probability threshold, determine supply pressure adjustment parameters based on the pipe burst probability, the supply pressure adjustment parameters including a target water pump, a target supply pressure, and a target water pump speed; and
adjust a water pump speed of the target water pump to the target water pump speed based on the supply pressure adjustment parameters to regulate a supply pressure of a pipeline network including the pipeline network node to the target supply pressure.

9. The system of claim 8, wherein the supply pressure adjustment parameters are related to at least one of a type of a target area, an area radius, and a traffic flow of the target area.

10. A method for city lifeline pipeline burst prevention based on an Internet of Things (IOT) large model, realized by a system for city lifeline pipeline burst prevention based on an IoT large model, the method comprising:
obtaining fluid pressure data;
determining a pipe burst probability of a pipeline network node based on the fluid pressure data; and
determining a target valve and a valve opening degree of the target valve based on the pipe burst probability, and controlling the target valve to the valve opening degree.

11. The method of claim 10, wherein the determining a pipe burst probability of a pipeline network node based on the fluid pressure data includes:
determining a target area based on the fluid pressure data;
determining a target monitoring device and shooting parameters corresponding to the target area based on the target area;
controlling the target monitoring device to adjust a shooting angle and a focal length based on the shooting parameters to obtain a road surface image of the target area;
determining a road surface water seepage feature based on the road surface image;
determining the pipe burst probability of the pipeline network node in the target area based on the road surface water seepage feature and the fluid pressure data; and
generating a risk avoidance instruction and broadcasting the risk avoidance instruction to vehicles in the target area in response to determining that the pipe burst probability exceeds a probability threshold.

12. The method of claim 11, wherein the determining a target area based on the fluid pressure data includes:
determining a monitoring center and an area radius based on the fluid pressure data and a pressure threshold; and
determining the target area based on the monitoring center and the area radius.

13. The method of claim 11, wherein the risk avoidance instruction includes a broadcast intensity, and the broadcast intensity is related to a type of the target area and/or a type of the vehicles.

14. The method of claim 11, wherein the determining the pipe burst probability of the pipeline network node in the target area based on the road surface water seepage feature and the fluid pressure data includes:
constructing a burst prediction map based on the road surface water seepage feature and the fluid pressure data;
determining a first pipe burst probability of the pipeline network node based on the burst prediction map using a first prediction model, wherein the first prediction model is a machine learning model;
determining a second pipe burst probability of the pipeline network node based on fluid pressure data of a preset historical period using a second prediction model; and
determining the pipe burst probability of the pipeline network node by performing weighted fusion on the first pipe burst probability and the second pipe burst probability.

15. The method of claim 14, wherein a time length of the preset historical period is related to the road surface water seepage feature and a water seepage threshold.

16. The method of claim 15, wherein in the weighted fusion, a weight of the second pipe burst probability is related to an area radius.

17. The method of claim 10, further comprising:
in response to determining that the pipe burst probability exceeds a probability threshold, determining supply pressure adjustment parameters based on the pipe burst probability, the supply pressure adjustment parameters including a target water pump, a target supply pressure, and a target water pump speed; and
adjusting a water pump speed of the target water pump to the target water pump speed based on the supply pressure adjustment parameters to regulate a supply pressure of a pipeline network including the pipeline network node to the target supply pressure.

18. The method of claim 17, wherein the supply pressure adjustment parameters are related to at least one of a type of a target area, an area radius, and a traffic flow of the target area.

19. A non-transitory computer-readable storage medium, wherein the storage medium stores computer instructions, and when the computer instructions are executed by at least one processor, the method of claim 10 is implemented.
